(19) United States
(12) Patent Application Publication
(10) Pub. No.: US 2025/0336612 A1
(43) Pub. Date: Oct. 30, 2025

(54) MULTILAYER CERAMIC CAPACITOR

(71) Applicant: Murata Manufacturing Co., Ltd., Nagaokakyo-shi (JP)

(72) Inventors: Shinya ISOTA, Nagaokakyo-shi (JP); Yuta OSHIMA, Nagaokakyo-shi (JP); Hayato FUKUSHIMA, Nagaokakyo-shi (JP)

(21) Appl. No.: 19/262,567

(22) Filed: Jul. 8, 2025

Related U.S. Application Data
(63) Continuation of application No. PCT/JP2024/023832, filed on Jul. 1, 2024.

(30) Foreign Application Priority Data
Aug. 31, 2023 (JP) 2023-141185

(51) Int. Cl. H01G 4/30; H01G 4/012; H01G 4/12; H01G 4/232

(52) U.S. Cl. CPC H01G 4/30; H01G 4/012; H01G 4/1227; H01G 4/2325

(57) ABSTRACT

A multilayer ceramic capacitor has a difference between a first silicon concentration at an outer layer position and a first silicon concentration at a side margin position is greater than or equal to about 0.2 mol % and less than or equal to about 2.5 mol %, and a first silicon concentration at an origin is greater than or equal to the first silicon concentration at the outer layer position and less than or equal to the first silicon concentration at the side margin position, or the first silicon concentration at the origin is less than or equal to the first silicon concentration at the outer layer position and greater than or equal to the first silicon concentration at the side margin position.

### CROSS REFERENCE TO RELATED APPLICATIONS

This application claims the benefit of priority to Japanese Patent Application No. 2023-141185 filed on Aug. 31, 2023 and is a Continuation application of PCT Application No. PCT/JP2024/023832 filed on Jul. 1, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

An internal portion of a multilayer ceramic capacitor includes portions with different lamination configurations from each other. Examples of portions with different lamination configurations from each other are a portion in which an inner electrode layer and an inner electrode layer are laminated to each other with a dielectric layer interposed therebetween and a portion in which only dielectric layers are laminated to each other.

Recently, there has been a demand for multilayer ceramic capacitors to have increased moisture resistance reliability. In particular, there has been a demand for a boundary between portions with different lamination configurations from each other to have moisture resistance reliability.

### SUMMARY OF THE INVENTION

Example embodiments of the present invention provide multilayer ceramic capacitors with increased moisture resistance reliability.

A multilayer ceramic capacitor according to an example embodiment of the present invention includes a ceramic element body including an inner layer portion in which first inner electrode layers and second inner electrode layers are alternately laminated with dielectric layers including first ceramic dielectrics interposed therebetween, the inner layer portion including a first inner-layer main surface in a lamination direction, a second inner-layer main surface on a side opposite to the first inner-layer main surface, a first inner-layer side surface in a width direction orthogonal or substantially orthogonal to the first inner-layer main surface and the second inner-layer main surface and at which the first inner electrode layers and the second inner electrode layers are extended, a second inner-layer side surface on a side opposite to the first inner-layer side surface at which the first inner electrode layers and the second inner electrode layers are extended, a first inner-layer end surface in a length direction orthogonal or substantially orthogonal to the first inner-layer main surface, the second inner-layer main surface, the first inner-layer side surface, and the second inner-layer side surface and at which the first inner electrode layers are extended, and a second inner-layer end surface on a side opposite to the first inner-layer end surface at which the second inner electrode layers are extended, a first outer layer portion including a second ceramic dielectric and covering the first inner-layer main surface in the lamination direction, a second outer layer portion including the second ceramic dielectric and covering the second inner-layer main surface from the lamination direction, a first side margin portion including the second ceramic dielectric and covering the inner layer portion, the first outer layer portion, and the second outer layer portion from one side in the width direction, a second side margin portion including the second ceramic dielectric and covering the inner layer portion, the first outer layer portion, and the second outer layer portion from another side in the width direction, and a terminal electrode at the ceramic element body and connected to a portion of the inner electrode layers, wherein, in the ceramic element body, two surfaces that face each other in the lamination direction are a first element-body main surface and a second element-body main surface, two surfaces that face each other in the width direction orthogonal or substantially orthogonal to the lamination direction are a first element-body side surface and a second element-body side surface, and two surfaces that face each other in the length direction orthogonal or substantially orthogonal to the lamination direction and the width direction are a first element-body end surface and a second element-body end surface, a length that is about ½ a length of each of the first outer layer portion and the second outer layer portion in the lamination direction is a first length, a length that is about ⅓ a length of each of the first side margin portion and the second side margin portion in the width direction is a second length, when, in a cross section of the ceramic element body in a plane parallel or substantially parallel to the width direction and the lamination direction at a central position of the multilayer ceramic capacitor in the length direction, at an interface between the first outer layer portion and the first side margin portion, a position defined by the first length in a direction toward the second element-body main surface from the first element-body main surface is an origin, at an interface between the first outer layer portion and the second side margin portion, a position defined by the first length in the direction toward the second element-body main surface from the first element-body main surface is an origin, at an interface between the second outer layer portion and the first side margin portion, a position defined by the first length in a direction toward the first element-body main surface from the second element-body main surface is an origin, and at an interface between the second outer layer portion and the second side margin portion, a position defined by the first length in the direction toward the first element-body main surface from the second element-body main surface is an origin, positions from the origins so as to be separated therefrom by the second length in a direction toward, of the first and second element-body side surfaces, the element-body side surface on a far side are each an outer layer position, positions from the origins so as to be separated therefrom by the second length in a direction toward, of the first and second element-body side surfaces, the element-body side surface on a near side are each a side margin position, a content percentage of silicon with respect to 100 mol of titanium at a position of each of the second ceramic dielectrics is a first silicon concentration, a difference between the first silicon concentration at the outer layer position with respect to one of the origins and the first silicon concentration at the side margin position with respect to the one of the origins is greater than or equal to about 0.2 mol % and less than or equal to about 2.5 mol %, the first silicon concentration at the one of the origins is greater than or equal to the first silicon concentration at the outer layer position with respect to the one of the origins and less than or equal to the first silicon concentration at the side margin position with respect to the one of the origins, or the first silicon concentration at the one of the origins is less than or equal to the first silicon concentration at the outer layer position with respect to the one of the origins and greater than or equal to the first silicon concentration at the side margin position with respect to the one of the origins.

According to example embodiments of the present invention, multilayer ceramic capacitors having increased moisture resistance reliability are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a multilayer ceramic capacitor according to an example embodiment of the present invention.

FIG. 2 is a sectional view along line I-I in FIG. 1.

FIG. 3 is a sectional view along line II-II in FIG. 1.

FIG. 4 is a sectional view along line III-III in FIG. 1.

FIG. 5 is a sectional view along line IV-IV in FIG. 1.

FIG. 6 is an enlarged view of a frame portion in FIG. 4.

FIG. 7 is a graph showing first silicon concentrations of dielectric layers.

FIG. 8 is an enlarged view of the frame portion in FIG. 4.

FIG. 9 is an enlarged view of the frame portion in FIG. 4.

FIG. 10 is a table showing the results of moisture resistance load tests.

FIG. 11 is a table showing the results of moisture resistance load tests.

FIG. 12 is a perspective view of a ceramic element-body core portion.

### DETAILED DESCRIPTION OF THE EXAMPLE EMBODIMENTS

Example embodiments of the present invention will be described in detail below with reference to the drawings.

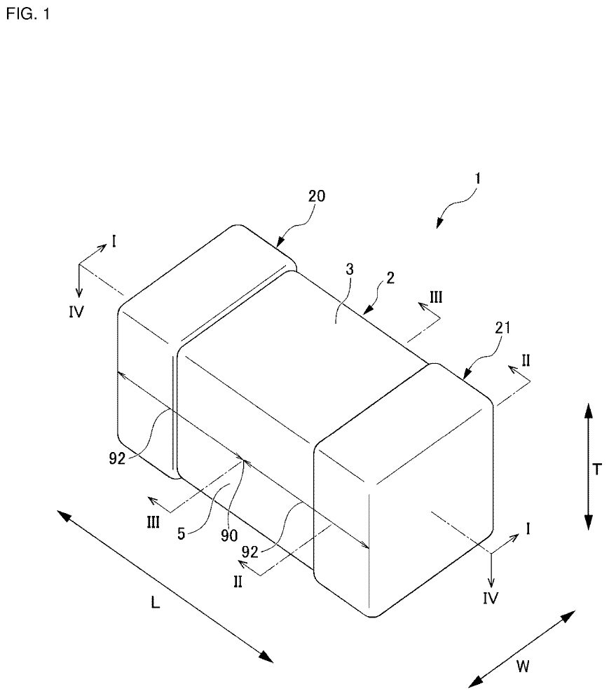

An example embodiment of the present invention is described based on FIG. 1. FIG. 1 is a perspective view of a multilayer ceramic capacitor 1 according to an example embodiment of the present invention. FIG. 1 shows a two-terminal multilayer ceramic capacitor.

The multilayer ceramic capacitor 1 includes a ceramic element body 2 and terminal electrodes. The terminal electrodes include a first terminal electrode 20 and a second terminal electrode 21.

The ceramic element body 2 includes a plurality of dielectric layers and a plurality of inner electrode layers that are laminated to each other. The inner electrode layers are laminated such that the dielectric layers are interposed therebetween. The shape of the ceramic element body 2 is a rectangular or substantially rectangular parallelepiped shape.

In the description below, a direction in which the dielectric layers and the inner electrode layers are laminated to each other is a lamination direction T. A direction orthogonal or substantially orthogonal to the lamination direction T is a width direction W. A direction orthogonal or substantially orthogonal to the lamination direction T and the width direction W is a length direction L.

Of two surfaces of the ceramic element body 2 that face each other in the lamination direction T, one of the surfaces is a first element-body main surface 3. The remaining one surface is a second element-body main surface 4. Of two surfaces of the ceramic element body 2 that face each other in the width direction W, one of the surfaces is a first element-body side surface 5. The remaining one surface is a second element-body side surface 6. Of two surfaces of the ceramic element body 2 that face each other in the length direction L, one of the surfaces is a first element-body end surface 7. The remaining one surface is a second element-body end surface 8.

In the description below, a cross section along line I-I in FIG. 1 is an LT cross section. A cross section along line II-II and a cross section along line III-III in FIG. 1 are WT cross sections. A cross section along line IV-IV in FIG. 1 is an LW cross section.

Portions where three surfaces of the ceramic element body 2 intersect each other are corners. Portions where two surfaces of the ceramic element body 2 intersect each other are edge-line portions. It is preferable that the corners and the edge-line portions are rounded.

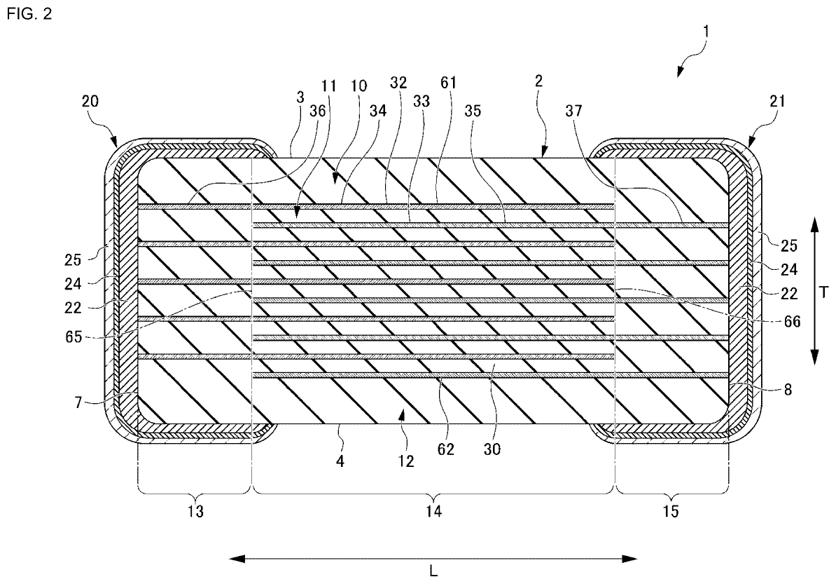

A state of lamination of the inner electrode layers is described based on FIG. 2. FIG. 2 is a sectional view along line I-I in FIG. 1.

First inner electrode layers 32 and second inner electrode layers 33 are laminated with dielectric layers 30 interposed therebetween. The dielectric layers 30 are made of ceramic dielectrics. The ceramic dielectrics of the dielectric layers 30 that are interposed between the first inner electrode layers 32 and the second inner electrode layers 33 are each a first ceramic dielectric.

The inner electrode layers include the plurality of first inner electrode layers 32 and the plurality of second inner electrode layers 33. The first inner electrode layers 32 are exposed at the first element-body end surface 7. The second inner electrode layers 33 are exposed at the second element-body end surface 8.

The first inner electrode layers 32 are each divided into a first facing electrode portion 34 and a first extended electrode portion 36. The first facing electrode portions 34 each face the second inner electrode layers 33. The first extended electrode portions 36 each extend from the corresponding first facing electrode portion 34 to the first element-body end surface 7.

The second inner electrode layers 33 are each divided into a second facing electrode portion 35 and a second extended electrode portion 37. The second facing electrode portions 35 each face the first inner electrode layers 32. The second extended electrode portions 37 each extend from the corresponding second facing electrode portion 35 to the second element-body end surface 8.

Divisions inside the ceramic element body 2 are described. A portion where the first inner electrode layers 32 and the second inner electrode layers 33 face each other in the lamination direction T is an inner layer portion 11. Each surface of the inner layer portion 11 is as follows. A surface of the inner layer portion 11 in the lamination direction T is a first inner-layer main surface 61. A surface on a side opposite to the first inner-layer main surface 61 is a second inner-layer main surface 62. A surface that extends in the width direction W orthogonal or substantially orthogonal to the first inner-layer main surface 61 and the second inner-layer main surface 62 and at which the first inner electrode layers 32 and the second inner electrode layers 33 are extended is a first inner-layer side surface 63. A surface that is on a side opposite to the first inner-layer side surface 63 and at which the first inner electrode layers 32 and the second inner electrode layers 33 are extended is a second inner-layer side surface 64. A surface that extends in the length direction L orthogonal or substantially orthogonal to the first inner-layer main surface 61, the second inner-layer main surface 62, the first inner-layer side surface 63, and the second inner-layer side surface 64 and at which the first inner electrode layers 32 are extended is a first inner-layer end surface 65. A surface that is on a side opposite to the first inner-layer end surface 65 and at which the second inner electrode layers 33 are extended is a second inner-layer end surface 66.

Outer layer portions and side margin portions are as follows. A portion that includes a ceramic dielectric and that covers the first inner-layer main surface 61 from the lamination direction T is a first outer layer portion 10. A portion that includes a ceramic dielectric and that covers the second inner-layer main surface 62 from the lamination direction T is a second outer layer portion 12. A portion that includes a ceramic dielectric and that covers the inner layer portion 11, the first outer layer portion 10, and the second outer layer portion 12 from one side in the width direction W is a first side margin portion 16. A portion that includes a ceramic dielectric and that covers the inner layer portion 11, the first outer layer portion 10, and the second outer layer portion 12 from the other side in the width direction W is a second side margin portion 18.

The ceramic dielectric of each of the first outer layer portion 10, the second outer layer portion 12, the first side margin portion 16, and the second side margin portion 18 is a second ceramic dielectric.

Only dielectric layers 30 are disposed in the first outer layer portion 10 and the second outer layer portion 12. The first inner electrode layers 32 and the second inner electrode layers 33 are not disposed in the first outer layer portion 10 and the second outer layer portion 12.

Divisions of the ceramic element body 2 in the length direction L are described. The ceramic element body 2 is divided into a first extended portion 13, a length-direction facing portion 14, and a second extended portion 15 in the length direction L.

The length-direction facing portion 14 corresponds to a range of the inner layer portion 11 in the length direction L. The first extended portion 13 is between the length-direction facing portion 14 and the first element-body end surface 7. The second extended portion 15 is between the length-direction facing portion 14 and the second element-body end surface 8.

The length-direction facing portion 14 corresponds to the facing electrode portions of the inner electrode layers. The first extended portion 13 and the second extended portion 15 correspond to the extended electrode portions of the inner electrode layers.

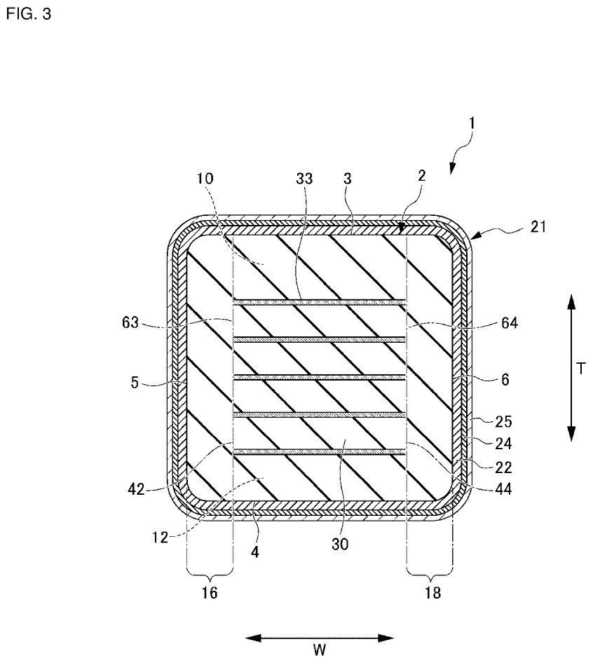

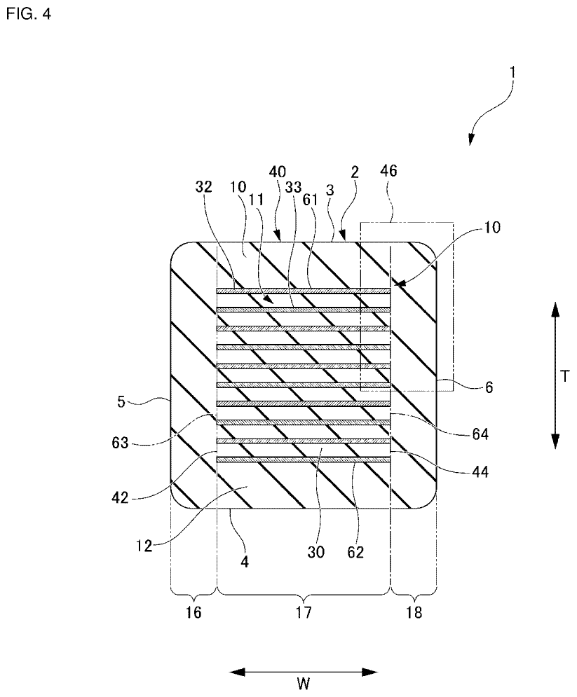

The side margin portions are described based on FIGS. 3 and 4. FIG. 3 is a sectional view along line II-II in FIG. 1. FIG. 4 is a sectional view along line III-III in FIG. 1. FIGS. 3 and 4 each show a WT cross section of the multilayer ceramic capacitor 1. FIG. 3 shows a WT cross section of the second extended portion 15. FIG. 4 shows a WT cross section of the length-direction facing portion 14.

As shown in FIG. 3, the first inner electrode layers 32 are not provided in the WT cross section of the second extended portion 15. Only the second inner electrode layers 33 provided in the WT cross section. Therefore, at the second element-body end surface 8, only the second inner electrode layers 33 are electrically connected to the second terminal electrode 21.

The second inner electrode layers 33 are not provided in the WT cross section of the first extended portion 13. Only the first inner electrode layers 32 are provided. At the first element-body end surface 7, only the first inner electrode layers 32 are electrically connected to the first terminal electrode 20.

In FIG. 1, a central position of the multilayer ceramic capacitor 1 in the length direction L is denoted as a length-direction central position 90. A length 91 and a length 92 in FIG. 1 are equal or substantially equal to each other. FIG. 4 shows a WT cross section at the length-direction central position 90 of the multilayer ceramic capacitor 1.

As shown in FIG. 4, the terminal electrodes are not provided in the WT cross section at the length-direction central position 90 of the multilayer ceramic capacitor 1. The first inner electrode layers 32 and the second inner electrode layers 33 are provided in the WT cross section. This is because the WT cross section at the length-direction central position 90 is a cross section of the inner layer portion 11.

As shown in FIG. 4, the ceramic element body 2 is divided into a first side margin portion 16, a width-direction facing portion 17, and a second side margin portion 18 in the width direction W.

The width-direction facing portion 17 is a portion where the first inner electrode layers 32 and the second inner electrode layers 33 face each other in the lamination direction T. The first side margin portion 16 is a portion between the width-direction facing portion 17 and the first element-body side surface 5. The second side margin portion 18 is a portion between the width-direction facing portion 17 and the second element-body side surface 6.

Only dielectric layers 30 are provided in the first side margin portion 16 and the second side margin portion 18. The first inner electrode layers 32 and the second inner electrode layers 33 are not provided in the first side margin portion 16 and the second side margin portion 18.

Here, the width-direction facing portion 17 is divided into the first outer layer portion 10, the inner layer portion 11, and the second outer layer portion 12 in the lamination direction T.

Therefore, the WT cross section at the length-direction central position 90 is divided into the first side margin portion 16, the first outer layer portion 10, the inner layer portion 11, the second outer layer portion 12, and the second side margin portion 18.

A portion of the ceramic element body 2 excluding the first side margin portion 16 and the second side margin portion 18 is a ceramic element-body core portion 40.

A line that indicates a boundary between the ceramic element-body core portion 40 and the first side margin portion 16 is a first boundary line 42. A line that indicates a boundary between the ceramic element-body core portion 40 and the second side margin portion 18 is a second boundary line 44.

The first boundary line 42 and the second boundary line 44 are imaginary lines. The first boundary line 42 and the second boundary line 44 are not lines that are actual lines.

By drawing a straight line through an end portion of each first inner electrode layer 32 on a side of the first element-body side surface 5 and an end portion of each second inner electrode layer 33 on the side of the first element-body side surface 5, the first boundary line 42 is drawn and can be determined. By drawing a straight line through an end portion of each first inner electrode layer 32 on a side of the second element-body side surface 6 and an end portion of each second inner electrode layer 33 on the side of the second element-body side surface 6, the second boundary line 44 is drawn and can be determined.

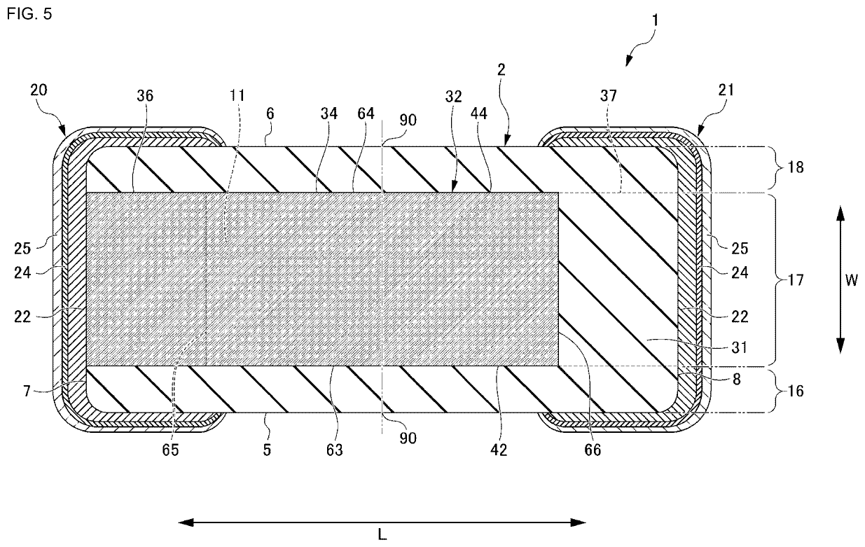

FIG. 5 is a sectional view along line IV-IV in FIG. 1. FIG. 5 shows, of the first inner electrode layers 32 and the second inner electrode layers 33, the first inner electrode layers 32.

As shown in FIG. 5, the first side margin portion 16 and the second side margin portion 18 are continuously provided from the first element-body end surface 7 to the second element-body end surface 8.

In the multilayer ceramic capacitor 1, a capacitance is generated by causing the first facing electrode portions 34 and the second facing electrode portions 35 to face each other with the corresponding dielectric layers 30 interposed therebetween. Therefore, the multilayer ceramic capacitor 1 provides capacitor characteristics.

Examples of the first ceramic dielectric and the second ceramic dielectric include as a main component, for example, barium titanate, calcium titanate, or strontium titanate. The dielectric ceramics may include a secondary component. Examples of the secondary component are, for example, rare earth oxides, silicon compounds, aluminum compounds, magnesium compounds, manganese compounds, iron compounds, chromium compounds, cobalt compounds, vanadium compounds, or nickel compounds. The ceramic dielectrics may be any dielectric as long as, for example, the dielectric is a perovskite-type oxide represented by ABO₃ and a B site element includes titanium the most.

The composition of the first ceramic dielectric and the composition of the second ceramic dielectric may be the same or different.

The thickness of one dielectric layer 30 is, for example, preferably greater than or equal to about 0.3 μm and less than or equal to about 10 μm.

The total number of dielectric layers 30 that are laminated in the ceramic element body 2 is, for example, preferably greater than or equal to 15 and less than or equal to 2000.

The main material of each inner electrode layer is a metal, such as, for example, nickel, copper, silver, palladium, or gold. The material of each inner electrode layer may be an alloy including at least one of the metals above, such as a silver-palladium alloy, for example.

1 The thickness of each inner electrode layer is, for example, preferably greater than or equal to about 0.2 μm and less than or equal to about 2.0 μm.

The total sum of the number of first inner electrode layers 32 and the number of second inner electrode layers 33 is, for example, preferably greater than or equal to 15 and less than or equal to 2000.

The size of the ceramic element body 2 is not particularly limited. For example, the length of the ceramic element body 2 in the length direction L is preferably greater than or equal to about 0.2 mm and less than or equal to about 10 mm. The length of the ceramic element body 2 in the width direction W is, for example, preferably greater than or equal to about 0.1 mm and less than or equal to about 5 mm. The length of the ceramic element body 2 in the lamination direction T is, for example, preferably greater than or equal to about 0.1 mm and less than or equal to about 5 mm.

The terminal electrodes are described. As shown in FIG. 1, the terminal electrodes include the first terminal electrode 20 and the second terminal electrode 21. The first terminal electrode 20 is connected to the first inner electrode layers 32. The second terminal electrode 21 is connected to the second inner electrode layers 33.

The first terminal electrode 20 is disposed at the first element-body end surface 7, a portion of the first element-body main surface 3, a portion of the second element-body main surface 4, a portion of the first element-body side surface 5, and a portion of the second element-body side surface 6. The second terminal electrode 21 is disposed at the second element-body end surface 8, a portion of the first element-body main surface 3, a portion of the second element-body main surface 4, a portion of the first element-body side surface 5, and a portion of the second element-body side surface 6.

Each terminal electrode includes, for example, an outer electrode film 22, a nickel plating film 24, and a tin plating film 25. These are disposed such that, from an end surface of the ceramic element body 2, the outer electrode film 22, the nickel plating film 24, and the tin plating film 25 are disposed in this order.

Each outer electrode film 22 is disposed on the end surface of the ceramic element body 2 and covers the end surface. Each outer electrode film 22 extends from the end surface to a part of a main surface and a portion of the side surface.

Each outer electrode film 22 includes glass and metal. Examples of the glass include boron and silicon. The metal includes at least one of, for example, copper, nickel, silver, palladium, a silver-palladium alloy, or gold. Each outer electrode film 22 is formed by coating the ceramic element body 2 with a conductive paste and firing the coated ceramic element body 2. The conductive paste includes glass and a metal. The thickness of each outer electrode film 22 is preferably, for example, greater than or equal to about 3 μm and less than or equal to about 100 μm.

Each nickel plating film 24 covers the corresponding outer electrode film 22. Each tin plating film 25 covers the corresponding nickel plating film 24.

When mounting the multilayer ceramic capacitor 1 to, for example, a substrate, for example, solder is used. Each nickel plating film 24 reduces or prevents corrosion of the corresponding outer electrode film 22 caused by the solder.

Each tin plating film 25 improves wettability of the solder with respect to the multilayer ceramic capacitor 1. As a result, the multilayer ceramic capacitor 1 is easily mounted to, for example, a substrate.

The size of the multilayer ceramic capacitor 1 is not particularly limited. The length in the length direction L of the multilayer ceramic capacitor 1 including the ceramic element body 2 and the terminal electrodes is, for example, preferably greater than or equal to about 0.2 mm and less than or equal to about 10 mm. The length in the lamination direction T of the multilayer ceramic capacitor 1 including the ceramic element body 2 and the terminal electrodes is, for example, preferably greater than or equal to about 0.1 mm and less than or equal to about 5 mm. The length in the width direction W of the multilayer ceramic capacitor 1 including the ceramic element body 2 and the terminal electrodes is, for example, preferably greater than or equal to about 0.1 mm and less than or equal to about 10 mm.

The quantity of silicon included in each dielectric layer 30 is described. The content percentage of silicon with respect to 100 mol of titanium at a particular position of each second ceramic dielectric is a first silicon concentration.

The content percentage of silicon with respect to 100 mol of titanium of an entire or substantially an entire portion of each second ceramic dielectric is a second silicon concentration. Specifically, the content percentage of silicon with respect to 100 mol of titanium of the entire or substantially the entire second ceramic dielectric of the first outer layer portion 10, the content percentage of silicon with respect to 100 mol of titanium of the entire or substantially the entire second ceramic dielectric of the second outer layer portion 12, the content percentage of silicon with respect to 100 mol of titanium of the entire or substantially the entire second ceramic dielectric of the first side margin portion 16, and the content percentage of silicon with respect to 100 mol of titanium of the entire or substantially the entire second ceramic dielectric of the second side margin portion 18 are each a second silicon concentration.

The content percentage of silicon with respect to 100 mol of titanium at a particular position of each first ceramic dielectric is a third silicon concentration.

In the multilayer ceramic capacitor 1 of the present example embodiment, the first outer layer portion 10, the second outer layer portion 12, the first side margin portion 16, and the second side margin portion 18 each include the second ceramic dielectric. The second silicon concentration of each of the first outer layer portion 10, the second outer layer portion 12, the first side margin portion 16, and the second side margin portion 18 is, for example, greater than or equal to about 1.0 mol % and less than or equal to about 3.5 mol %.

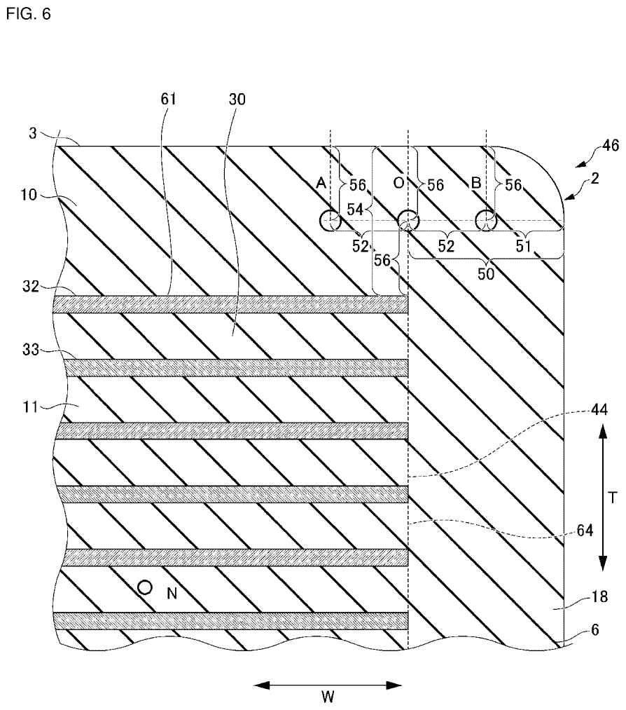

FIG. 6 is an enlarged view of a frame portion 46 in FIG. 4. An origin O, an outer layer position A, and a side margin position B are determined as follows. In the description below, the first outer layer portion 10 and the second side margin portion 18 are taken as examples. However, in the description below, the same applies to the second outer layer portion 12 and the first side margin portion 16.

In FIG. 4, the length of the first outer layer portion 10 in the lamination direction T is indicated as length 54. A length that is about ½ the length 54 is indicated as length 56. The length 56 is a first length 56.

In FIG. 4, the length of the second side margin portion 18 in the width direction W is indicated as length 50. A length that is about ⅓ the length 50 is indicated as length 52. The length 52 is a second length 52. A length 51 is about ⅔ the length 50.

In the WT cross section at the length-direction central position 90 of the multilayer ceramic capacitor 1, a position situated on the second boundary line 44 and defined by the first length 56 in a direction toward the second element-body main surface 4 from the first element-body main surface 3 is the origin O.

A position situated from the origin O so as to be separated therefrom by the second length 52 in a direction toward the first element-body side surface 5 that is, of the first element-body side surface 5 and the second element-body side surface 6, the side surface on a far side is an outer layer position A. The first silicon concentration at the outer layer position A is an outer-layer-portion silicon concentration.

A position situated from the origin O so as to be separated therefrom by the second length 52 in a direction toward the second element-body side surface 6 that is, of the first element-body side surface 5 and the second element-body side surface 6, the side surface on a near side is a side margin position B. The first silicon concentration at the side margin position B is a side-margin-portion silicon concentration.

The difference between the outer-layer-portion silicon concentration and the side-margin-portion silicon concentration is, for example, greater than or equal to about 0.2 mol % and less than or equal to about 2.5 mol %.

The first silicon concentration at the origin O is an origin silicon concentration. The origin O is located at a boundary between the outer layer portion and the side margin portion. Objects to be measured in terms of the origin silicon concentration include the outer layer portion and the side margin portion. The origin silicon concentration is a concentration whose value is between the value of the outer-layer-portion silicon concentration and the value of the side-margin-portion silicon concentration.

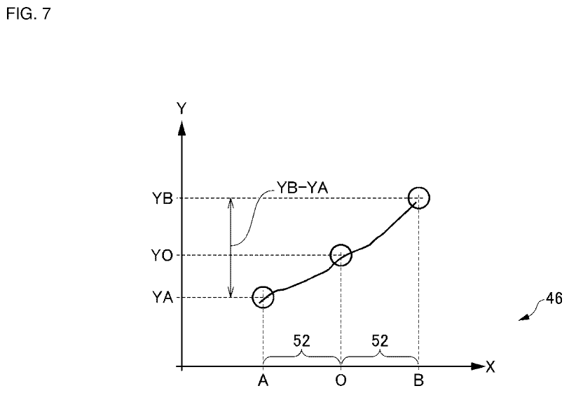

The tendency of the first silicon concentrations is described based on FIG. 7. FIG. 7 is a graph showing the first silicon concentration of the first outer layer portion 10 and the first silicon concentration of the second side margin portion 18. The X axis of FIG. 7 indicates a position in the width direction W. The Y axis in FIG. 7 indicates the first silicon concentration.

Points A, O, and B shown in FIG. 7 are the outer layer position A, the origin O, and the side margin position B, respectively, described based on FIG. 6. Point YA in FIG. 7 indicates the first silicon concentration at the outer layer position A. Point YB in FIG. 7 indicates the first silicon concentration at the side margin position B.

The first silicon concentration YA and the first silicon concentration YB are, for example, greater than or equal to about 1.0 mol % and less than or equal to about 3.5 mol %. The difference between the first silicon concentration YA and the first silicon concentration YB is, for example, greater than or equal to about 0.2 mol % and less than or equal to about 2.5 mol %.

FIG. 7 exemplifies a case in which the first silicon concentration YA at the outer layer position A is less than the first silicon concentration YB at the side margin position B. If the difference between the first silicon concentration YA and the first silicon concentration YB is, for example, greater than or equal to about 0.2 mol % and less than or equal to about 2.5 mol %, the first silicon concentration YA at the outer layer position A may be greater than the first silicon concentration YB at the side margin position B.

Point YO in FIG. 7 indicates the first silicon concentration at the origin O. The first silicon concentration YO is greater than or equal to the first silicon concentration YA and less than or equal to the first silicon concentration YB, or is less than or equal to the first silicon concentration YA and greater than or equal to the first silicon concentration YB. The first silicon concentrations change in the same or substantially the same manner from the outer layer position A to the side margin position B with the origin O being interposed therebetween.

The first silicon concentration YO is preferably an intermediate value between the first silicon concentration YA and the first silicon concentration YB. Intermediate value refers to, for example, a value in a range that is within about ±5% of ((first silicon concentration YA+first silicon concentration YB)/2).

As shown in FIG. 6, any position in the inner layer portion 11 at a WT cross section of the ceramic element body 2 at the length-direction central position 90 is an inner layer position N. The third silicon concentration at the inner layer position N is an inner-layer-portion silicon concentration.

A preferred relationship between the inner-layer-portion silicon concentration, the outer-layer-portion silicon concentration, and the side-margin-portion silicon concentration is as follows:

inner-layer-portion silicon concentration<outer-layer-portion silicon concentration<side-margin-portion silicon concentration

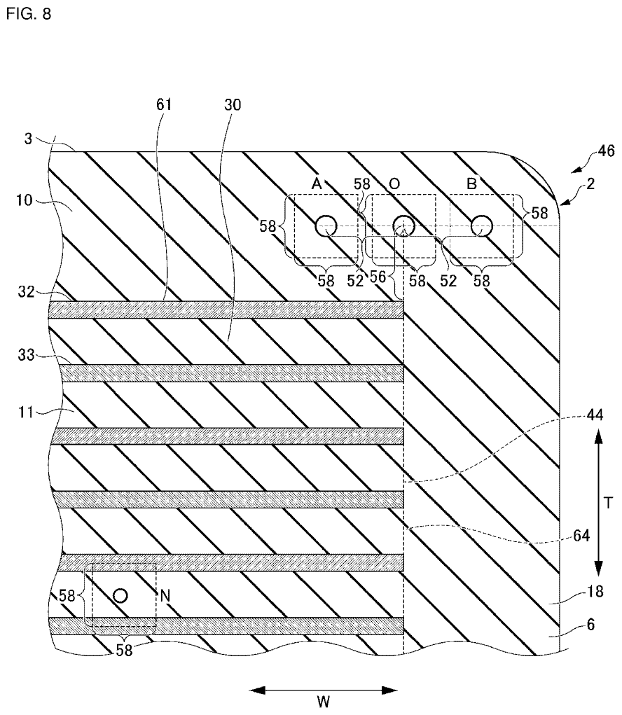

An example of a method of measuring the first to third silicon concentrations is described based on FIG. 8. The first to third silicon concentrations are measured by a composition analysis of the dielectric layers 30. The multilayer ceramic capacitor 1 is polished to expose the WT cross section at the length-direction central position 90.

The first to third silicon concentrations are measured by composition analysis by performing laser ablation ICP-MS (LA-ICP-MS) on the WT cross section. Spot shapes at the time of the composition analysis are square or substantially square shapes whose centers are, respectively, the outer layer position A, the side margin position B, the inner layer position N, and the origin O. The length of one side of a square shape is, for example, about 5 μm.

The second silicon concentrations are measured by EDX (Energy Dispersive X-ray Spectroscopy). A measurement range is the first outer layer portion 10, the second outer layer portion 12, the first side margin portion 16, and the second side margin portion 18 in their entirety or substantially their entirety in a cross section parallel or substantially parallel to the width direction and the lamination direction.

Particle sizes of dielectric particles included in the dielectric layers 30 are described. In the multilayer ceramic capacitor 1 of the present example embodiment, a central-value particle size of a dielectric particle included in the dielectric layer 30 at the origin O is, for example, greater than or equal to about 0.4 times and less than or equal to about 0.9 times a central-value particle size of a dielectric particle included in the dielectric layer 30 at the side margin position B. Central-value particle size is also referred to as a median diameter and D50.

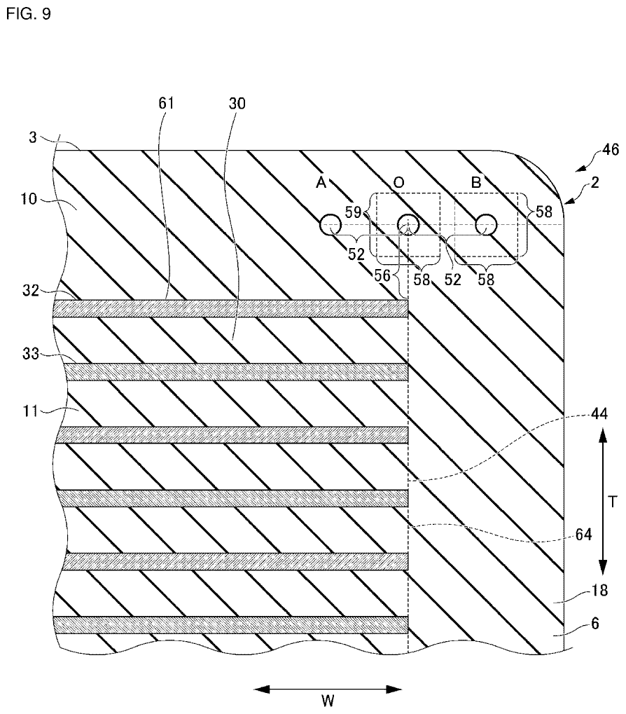

An example of a method of measuring the particle size of each dielectric particle is described based on FIG. 9. FIG. 9 is a diagram showing measurement positions and measurement ranges in measuring the particle sizes of the dielectric particles. FIG. 9 is an enlarged view of the frame portion 46 in FIG. 4.

The particle sizes of the dielectric particles are measured by using a scanning electron microscope (SEM). The measurement is performed at the WT cross section at the length-direction central position 90 of the multilayer ceramic capacitor 1.

The multilayer ceramic capacitor 1 is polished up to the length-direction central position 90 to expose the WT cross section. At the WT cross section, an SEM image of each dielectric particle is photographed under a magnification of about 30000×, an acceleration voltage of about 5 kV, and a field of view of about 3 μm×about 3 μm. By using image processing software, edges of all of the dielectric particles included in the SEM image are recognized to calculate the cross-sectional area of the dielectric particles. An equivalent circle diameter is calculated from the calculated cross-sectional area. The calculated equivalent circle diameter is the diameter of each particle. By excluding the dielectric particles photographed with missing portions, the diameters of all of the dielectric particles included within a photographed range are measured to determine their average value.

The multilayer ceramic capacitor 1 of the present example embodiment can be provided as a multilayer ceramic capacitor 1 having increased moisture resistance reliability.

As shown in FIG. 7, the outer-layer-portion silicon concentration and the side-margin-portion silicon concentration are each, for example, greater than or equal to about 1.0 mol % and less than or equal to about 3.5 mol %.

The difference between the outer-layer-portion silicon concentration and the side-margin-portion silicon concentration is, for example, greater than or equal to about 0.2 mol % and less than or equal to about 2.5 mol %.

Further, the origin silicon concentration is greater than or equal to the outer-layer-portion silicon concentration and less than or equal to the side-margin-portion silicon concentration, or is less than or equal to the outer-layer-portion silicon concentration and greater than or equal to the side-margin-portion silicon concentration.

That is, the outer-layer-portion silicon concentration and the side-margin-portion silicon concentration are within a predetermined preferred range, and the silicon concentrations change in the same or substantially the same manner from the outer layer position A to the side margin position B.

Since each silicon concentration falls within such a range described above with the second boundary line 44 being interposed therebetween, and tends to change as described above, the moisture resistance reliability of the multilayer ceramic capacitor 1 is increased.

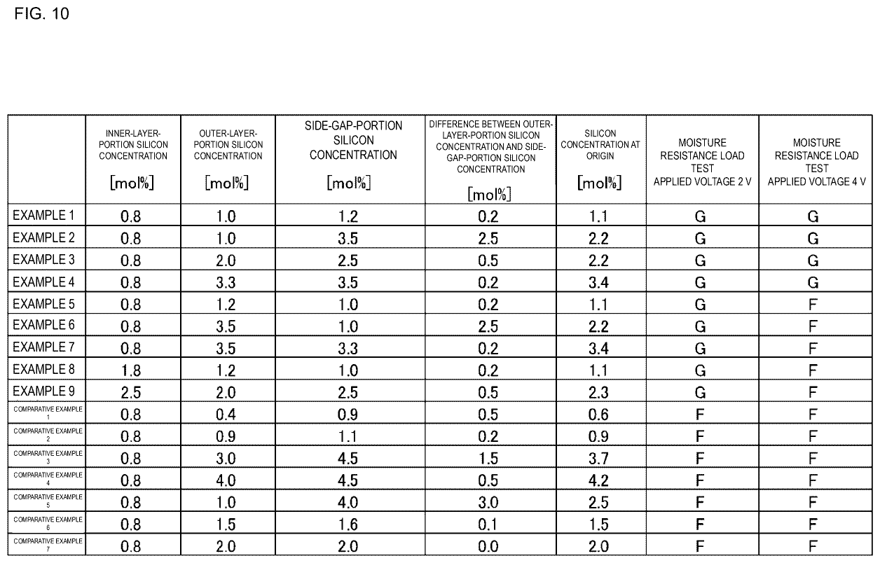

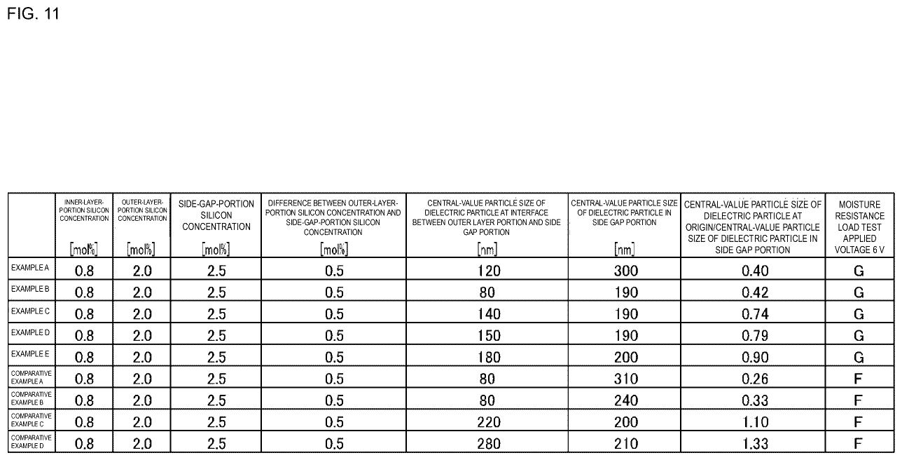

Results of moisture resistance load tests of examples and comparative examples are described based on FIGS. 10 and 11. As chips of the examples and the comparative examples, chips of multilayer ceramic capacitors below are used. For example, the length in the length direction L of each chip including a terminal electrode is about 1.6 mm, its length in the width direction W is about 0.8 mm, and its length in the lamination direction T is about 0.8 mm. For example, the thickness of each dielectric layer 30 in the inner layer portion 11 is, for example, about 0.5 μm, the thickness of each inner electrode layer is, for example, about 0.5 μm, and the number of dielectric layers 30 is 705. The thickness of each dielectric layer 30 here means the distance in the lamination direction T between the inner electrode layers that are adjacent to each other. The number of dielectric layers 30 is the number of portions between the inner electrode layers that are adjacent to each other in the inner layer portion 11. The length 54 of the first outer layer portion 10 in the lamination direction T and the length of the second outer layer portion 12 in the lamination direction T are, for example, about 45 μm. The length of the first side margin portion 16 in the width direction W and the length 50 of the second side margin portion 18 in the width direction W are, for example, about 30 μm.

The conditions for the moisture resistance load tests performed on the chips of the examples and the comparative examples are described. For 100 chips, the moisture resistance load tests were performed under a temperature of, for example, about 125 degrees, a humidity of, for example, about 95% RH, and applied voltages of, for example, about 2 V, for example, about 4 V, and, for example, about 6 V, and insulation resistances IR after the passage of, for example, about 72 hours were measured. Chips that became Log IR≤4 were determined as being defective, and a defective rate was calculated from the number of defective chips. When the calculated defective rate was less than, for example, about 10%, the result was determined as being good. When the calculated defective rate was greater than or equal to, for example, about 10%, the result was determined as being poor.

FIG. 10 shows the results of the moisture resistance load tests for the chips of the examples and the comparative examples. In FIG. 10, a good moisture resistance load test result is denoted by G. A poor moisture resistance load test result is denoted by F.

As indicated in Example 1 to Example 9, when the outer-layer-portion silicon concentration and the side-margin-portion silicon concentration were greater than or equal to about 1.0 mol % and less than or equal to about 3.5 mol %, when the difference between the outer-layer-portion silicon concentration and the side-margin-portion silicon concentration was, for example, greater than or equal to about 0.2 mol % and less than or equal to about 2.5 mol %, and when the origin silicon concentration was greater than or equal to the outer-layer-portion silicon concentration and less than or equal to the side-margin-portion silicon concentration, or was less than or equal to the outer-layer-portion silicon concentration and greater than or equal to the side-margin-portion silicon concentration, the results were good when the applied voltage was, for example, about 2 V in the moisture resistance load tests.

As indicated in Comparative Example 1 to Comparative Example 7, when any one of the silicon concentration conditions satisfied by Example 1 to Example 9 above was not satisfied, the results were poor when the applied voltage was about 2 V in the moisture resistance load tests.

Further, as indicated in Example 1 to Example 4, when each silicon concentration was such that the inner-layer-portion silicon concentration<outer-layer-portion silicon concentration<side-margin-portion silicon concentration, the results were good even if the applied voltage was about 4 V in the moisture resistance load tests.

Based on FIG. 11, the central-value particle diameters of dielectric particles and the results of the moisture resistance load tests are described. FIG. 11 shows the results of the moisture resistance load tests for chips of examples and comparative examples. In FIG. 11, a good moisture resistance load test result is denoted by G. A poor moisture resistance load test result is denoted by F.

In Example A to Example E, the central-value particle size of the dielectric particle included in the dielectric layer 30 at the origin O is, for example, greater than or equal to about 0.4 times and less than or equal to about 0.9 times the central-value particle diameter of the dielectric particle included in the dielectric layer 30 at the side margin position B, that is, at the side margin portion.

In Example A to Example E, as shown in FIG. 11, the results were good even if the applied voltage was about 6 V in the moisture resistance load tests.

As indicated in Comparative Example A to Comparative Example D, when any one of central-value particle size conditions of the dielectric particles satisfied by Example A to Example E above was not satisfied, the results were poor when the applied voltage was about 6 V in the moisture resistance load tests.

The proportion of the length 52 with respect to the length 50 that is a length of the second side margin portion 18 in the width direction W is not limited to about ⅓, and may be, for example, about ¼. The length 52 need not be determined as a proportion with respect to the length 50. For example, the length 52 may be a certain value, such as about 10 μm, for example. For example, the length 52 can be determined as appropriate in accordance with the length of the side margin portion in the width direction W.

The reason that the moisture resistance reliability of the multilayer ceramic capacitor 1 of the present example embodiment is increased may be as follows. A desired amount of silicon is included in the dielectric layers 30 from the outer layer portion to the side margin portion. In addition, the amount of silicon changes in the same or substantially the same way from the side margin portion to the outer layer portion. Therefore, the adhesion strength between the outer layer portion and the side margin portion is increased. As a result, the moisture resistance reliability is increased.

The relationship between the central-value particle size of each dielectric particle and the moisture resistance reliability may be as follows. The particle size of the dielectric particle in each dielectric layer 30 is preferably uniform. This is because distortion is unlikely to occur in each dielectric layer 30. In the multilayer ceramic capacitor 1 of the present example embodiment, the central-value particle size of the dielectric particle included in the dielectric layer 30 near the origin O is, for example, greater than or equal to about 0.4 times and less than or equal to about 0.9 times the central-value particle size of the dielectric particle included in the dielectric layer 30 at the side margin portion. That is, a proportion between the central-value particle size of the dielectric particle in the side margin portion and the central-value particle size of a dielectric particle in a predetermined range extending in the direction of the side margin position B and in the direction of the outer layer position A from, as the center, a location near an interface, that is, the origin O is within a predetermined range, the interface being situated between the outer layer portion and the side margin portion. Therefore, in each dielectric layer 30, distortion or the like is unlikely to occur between the dielectric particles and at steps in an arrangement of the dielectric particles. Therefore, in the multilayer ceramic capacitor 1 of the present example embodiment, moisture resistance reliability is increased.

An example of a method of producing the multilayer ceramic capacitor 1 is described.

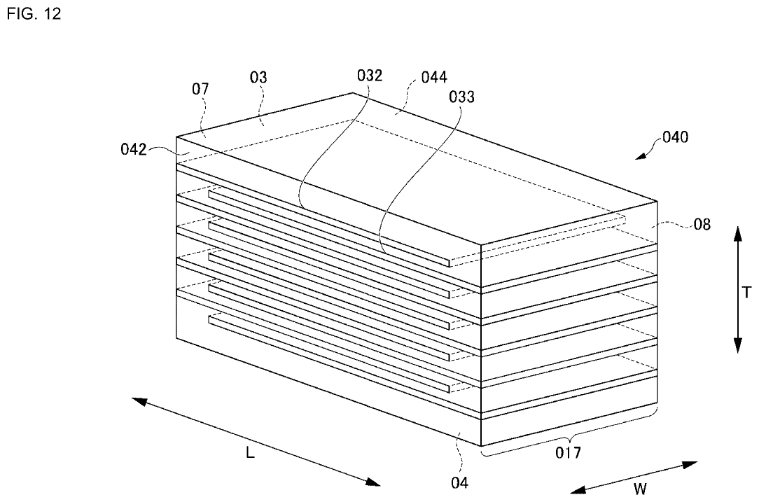

(1) A ceramic element-body core-portion precursor 040 is prepared. As shown in FIG. 12, the ceramic element-body core-portion precursor 040 is a precursor of the ceramic element body before dielectric sheets for side margin portions are disposed. Precursor means before firing. In the ceramic element body, a portion excluding the side margin portions is a ceramic element-body core portion.

Dielectric sheets for the ceramic element-body core portion and conductive pastes for inner electrode layers are prepared. The dielectric sheets and the conductive pastes for inner electrode layers each include a binder and a solvent. The binder and the solvent may be a publicly known organic binder and a publicly known organic solvent.

(2) The conductive pastes for the inner electrode layers are applied by printing with a predetermined pattern on the dielectric sheets. This forms an inner-electrode-layer pattern on each dielectric sheet. An example of a printing method is screen printing or gravure printing.

(3) A predetermined number of dielectric sheets on which the inner-electrode-layer patterns are not printed are laminated. The laminated layers become a layer including one of outer layer portions. The dielectric sheets on which the inner-electrode-layer patterns have been printed are successively laminated thereon. The laminated layers become a layer including an inner layer portion. A predetermined number of dielectric sheets on which the inner-electrode-layer patterns are not printed are laminated thereon. The laminated layers become a layer including the other outer layer portion.

(4) The laminated sheets are pressed in the lamination direction to form a laminated block. An example of a pressing method is isostatic pressure pressing.

(5) The laminated block is cut. When cutting, the conductive pastes corresponding to the inner electrode layers are exposed at two sides in the width direction W. The cut laminated block is the ceramic element-body core-portion precursor 040. FIG. 12 is a perspective view of the ceramic element-body core-portion precursor 040.

The dielectric sheets for forming the side margin portions are disposed on two sides of the ceramic element-body core-portion precursor 040 in the width direction W. Thereafter, after firing and cutting, a ceramic element body 2 is formed. In FIG. 12, each portion of the ceramic element-body core-portion precursor 040 is labeled with a member number including a “0” in front of a member number of a corresponding member of the ceramic element body 2. For example, a portion 032 of the ceramic element-body core-portion precursor 040 corresponds to a first inner electrode layer 32 of the ceramic element body 2.

(6) The dielectric sheets for the side margin portions are formed. Specifically, the dielectric material may be the same as the dielectric material for the ceramic element-body core portion. An additive may be added to dielectric powder obtained from the dielectric material. The dielectric sheets for the side margin portions may each have a two-layer structure including an outer side layer and an inner side layer that contacts the ceramic element-body core-portion precursor 040. Solvents and additives included in each inner side layer and each outer side layer may differ from each other.

In the dielectric sheets for the ceramic element-body core portion and the dielectric sheets for the side margin portions, silicon is added to at least the dielectric sheets for the side margin portions. The silicon concentrations of the dielectric sheets for the ceramic element-body core portion and the silicon concentrations of the dielectric sheets for the side margin portions are made to differ from each other. Preferably, the silicon concentrations of the dielectric sheets for the side margin portions are higher than the silicon concentrations of the dielectric sheets for the ceramic element-body core portion.

In the dielectric sheets for the ceramic element-body core portion, the silicon concentrations of the dielectric sheets corresponding to the inner layer portion and the silicon concentrations of the dielectric sheets corresponding to the outer layer portions may be made to differ from each other.

(7) The dielectric sheet for one of the side margin portions is pushed against the ceramic element-body core-portion precursor 040. By performing punching, a layer that becomes the side margin portion is formed. Next, similarly, the dielectric sheet for the other side margin portion is made to face the dielectric sheets for the inner layer portion and is pushed against the other side of the ceramic element-body core-portion precursor 040. Then, by performing punching, a layer that becomes the side margin portion on the other side is formed. The punching may be performed after the dielectric sheets for the side margin portions are pushed against the respective two sides of the ceramic element-body core-portion precursor 040.

(11) A laminated chip where the layers that become the side margin portions have been formed is degreased in a nitrogen atmosphere, for example. Then, the laminated chip is fired at a predetermined temperature in, for example, a nitrogen-hydrogen-water-vapor mixture atmosphere to obtain a sintered ceramic element body. The firing is to be performed at a temperature at which the laminated chip is sufficiently densified. The firing is to be performed, for example, at a temperature greater than or equal to about 1200° C. and less than or equal to about 1300° C. fora duration greater than or equal to 0 minutes and less than or equal to about 30 minutes. The firing is performed in an atmosphere in which a main component compound, such as BaTiO₃, for example, is not reduced and oxidation of the conductive material is reduced or prevented. The firing is to be performed in, for example, an N₂—H₂—H₂O air current at an oxygen partial pressure of about 1.8×10⁻⁹ to about 8.7×10⁻¹⁰ MPa. Further, annealing may be performed after the firing.

(12) Terminal electrodes are each formed at a corresponding one of two end surfaces of the ceramic element body that has been sintered. By performing the above, the multilayer ceramic capacitor 1 is produced. The terminal electrodes are to be formed by a publicly known method. For example, foundation layers are formed by applying and burning a conductive paste whose main component is a conductive component, such as Cu or Ni, to end surfaces where the inner electrodes of an element body portion have been extended and exposed. Each foundation layer may be formed by a method of performing firing after the conductive pastes have each been applied to a corresponding one of two end surfaces of a green element body portion before the firing. After forming each foundation layer, each foundation layer is to be subjected to, for example, electrolytic plating to form a plating film, such as an Ni film or an Sn film, on a surface of each foundation layer. This forms the multilayer ceramic capacitor.

As described above, the silicon concentrations of the dielectric sheets for the ceramic element-body core portion and the silicon concentration of the dielectric sheet for each side margin portion differ from each other. Therefore, during the firing, silicon moves. As a result, a gradient of silicon concentration is provided between each outer layer portion and each side margin portion.

Although example embodiments of the present invention have been described above, various changes and modifications can be made in the present invention without being limited to the example embodiments described above.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a ceramic element body including:
an inner layer portion including first inner electrode layers and second inner electrode layers alternately laminated with dielectric layers including first ceramic dielectrics interposed therebetween, the inner layer portion including a first inner-layer main surface in a lamination direction, a second inner-layer main surface on a side opposite to the first inner-layer main surface, a first inner-layer side surface in a width direction orthogonal or substantially orthogonal to the first inner-layer main surface and the second inner-layer main surface and at which the first inner electrode layers and the second inner electrode layers are extended, a second inner-layer side surface on a side opposite to the first inner-layer side surface and at which the first inner electrode layers and the second inner electrode layers are extended, a first inner-layer end surface in a length direction orthogonal or substantially orthogonal to the first inner-layer main surface, the second inner-layer main surface, the first inner-layer side surface, and the second inner-layer side surface and at which the first inner electrode layers are extended, and a second inner-layer end surface on a side opposite to the first inner-layer end surface and at which the second inner electrode layers are extended;
a first outer layer portion including a second ceramic dielectric and covering the first inner-layer main surface from the lamination direction;
a second outer layer portion including a second ceramic dielectric and covering the second inner-layer main surface from the lamination direction;
a first side margin portion including the second ceramic dielectric and covering the inner layer portion, the first outer layer portion, and the second outer layer portion from one side in the width direction; and
a second side margin portion including the second ceramic dielectric and covering the inner layer portion, the first outer layer portion, and the second outer layer portion from another side in the width direction; and
a terminal electrode at the ceramic element body and connected to a portion of the inner electrode layers; wherein
in the ceramic element body, two surfaces facing each other in the lamination direction are a first element-body main surface and a second element-body main surface, two surfaces facing each other in the width direction are a first element-body side surface and a second element-body side surface, and two surfaces facing each other in the length direction are a first element-body end surface and a second element-body end surface;
a length that is about ½ of a length of each of the first outer layer portion and the second outer layer portion in the lamination direction is a first length, a length that is about ⅓ of a length of each of the first side margin portion and the second side margin portion in the width direction is a second length, in a cross section of the ceramic element body in a plane parallel or substantially parallel to the width direction and the lamination direction at a central position of the multilayer ceramic capacitor in the length direction;
at an interface between the first outer layer portion and the first side margin portion, a position defined by the first length in a direction toward the second element-body main surface from the first element-body main surface is an origin;
at an interface between the first outer layer portion and the second side margin portion, a position defined by the first length in the direction toward the second element-body main surface from the first element-body main surface is an origin;
at an interface between the second outer layer portion and the first side margin portion, a position defined by the first length in a direction toward the first element-body main surface from the second element-body main surface is an origin;
at an interface between the second outer layer portion and the second side margin portion, a position defined by the first length in the direction toward the first element-body main surface from the second element-body main surface is an origin;
positions situated from the origins corresponding thereto so as to be separated therefrom by the second length in a direction toward, of the first and second element-body side surfaces, an element-body side surface on a far side are each an outer layer position;
positions situated from the origins so as to be separated therefrom by the second length in a direction toward, of the first and second element-body side surfaces, the element-body side surface on a near side are each a side margin position;
a content percentage of silicon with respect to 100 mol of titanium at a position of each of the second ceramic dielectrics is a first silicon concentration;
a difference between the first silicon concentration at the outer layer position with respect to one of the origins and the first silicon concentration at the side margin position with respect to the one of the origins is greater than or equal to about 0.2 mol % and less than or equal to about 2.5 mol %; and
the first silicon concentration at the one of the origins is greater than or equal to the first silicon concentration at the outer layer position with respect to the one of the origins and less than or equal to the first silicon concentration at the side margin position with respect to the one of the origins; or
the first silicon concentration at the one of the origins is less than or equal to the first silicon concentration at the outer layer position with respect to the one of the origins and greater than or equal to the first silicon concentration at the side margin position with respect to the one of the origins.

2. The multilayer ceramic capacitor according to claim 1, wherein
in the cross section of the ceramic element body in the plane parallel or substantially parallel to the width direction and the lamination direction at the central position of the multilayer ceramic capacitor in the length direction, a content percentage of silicon with respect to 100 mol of titanium at an entirety or substantially an entirety of the second ceramic dielectric of the first outer layer portion is a second silicon concentration, a content percentage of silicon with respect to 100 mol of titanium at an entirety or substantially an entirety of the second ceramic dielectric of the second outer layer portion is the second silicon concentration, a content percentage of silicon with respect to 100 mol of titanium at an entirety or substantially an entirety of the second ceramic dielectric of the first side margin portion is the second silicon concentration, and a content percentage of silicon with respect to 100 mol of titanium at an entirety of the second ceramic dielectric of the second side margin portion is the second silicon concentration; and
the second silicon concentration of each of the first outer layer portion, the second outer layer portion, the first side margin portion, and the second side margin portion is greater than or equal to about 1.0 mol % and less than or equal to about 3.5 mol %.

3. The multilayer ceramic capacitor according to claim 1, wherein
a content percentage of silicon with respect to 100 mol of titanium at a particular position of each of the first ceramic dielectrics is a third silicon concentration;
the first silicon concentration at the outer layer position with respect to the one of the origins is less than the first silicon concentration at the side margin position with respect to the one of the origins; and
in the cross section of the ceramic element body in the plane parallel or substantially parallel to the width direction and the lamination direction at the central position of the multilayer ceramic capacitor in the length direction, the third silicon concentration of the inner layer portion is less than the first silicon concentration at the outer layer position with respect to the one of the origins.

4. The multilayer ceramic capacitor according to claim 1, wherein a central-value particle size of a dielectric particle included in the dielectric layer at or adjacent to the one of the origins is greater than or equal to about 0.4 times and less than or equal to about 0.9 times a central-value particle size of a dielectric particle included in the dielectric layer at the side margin position with respect to the one of the origins.

5. The multilayer ceramic capacitor according to claim 1, wherein the ceramic element body includes rounded corners and edge-line portions.

6. The multilayer ceramic capacitor according to claim 1, wherein the first and second outer portions do not include either of the first inner electrode layers or the second inner electrode layers.

7. The multilayer ceramic capacitor according to claim 1, wherein the first and second side margin portions do not include either of the first inner electrode layers or the second inner electrode layers.

8. The multilayer ceramic capacitor according to claim 1, wherein the first ceramic dielectric includes titanate, calcium titanate, or strontium titanate as a main component.

9. The multilayer ceramic capacitor according to claim 8, wherein the first ceramic dielectric includes rare earth oxides, silicon compounds, aluminum compounds, magnesium compounds, manganese compounds, iron compounds, chromium compounds, cobalt compounds, vanadium compounds, or nickel compounds as a secondary component.

10. The multilayer ceramic capacitor according to claim 1, wherein the second ceramic dielectric includes titanate, calcium titanate, or strontium titanate as a main component.

11. The multilayer ceramic capacitor according to claim 10, wherein the second ceramic dielectric includes rare earth oxides, silicon compounds, aluminum compounds, magnesium compounds, manganese compounds, iron compounds, chromium compounds, cobalt compounds, vanadium compounds, or nickel compounds as a secondary component.

12. The multilayer ceramic capacitor according to claim 1, wherein a thickness of each of the dielectric layers is greater than or equal to about 0.3 μm and less than or equal to about 10 μm.

13. The multilayer ceramic capacitor according to claim 1, wherein a total number of the dielectric layers is greater than or equal to 15 and less than or equal to 2000.

14. The multilayer ceramic capacitor according to claim 1, wherein a main material of each of the first and second inner electrode layers includes nickel, copper, silver, palladium, or gold.

15. The multilayer ceramic capacitor according to claim 1, wherein a thickness of each of the first and second inner electrode layers is greater than or equal to about 0.2 μm and less than or equal to about 2.0 μm.

16. The multilayer ceramic capacitor according to claim 1, wherein a total number of the first and second inner electrode layers is greater than or equal to 15 and less than or equal to 2000.

17. The multilayer ceramic capacitor according to claim 1, wherein
a dimension of ceramic element body in the length direction is greater than or equal to about 0.2 mm and less than or equal to about 10 mm;
a dimension of the ceramic element body in the width direction is greater than or equal to about 0.1 mm and less than or equal to about 5 mm; and
a dimension of the ceramic element body in the lamination direction is greater than or equal to about 0.1 mm and less than or equal to about 5 mm.

18. The multilayer ceramic capacitor according to claim 1, wherein the terminal electrode includes an outer electrode film, a nickel plating film, and a tin plating film.

19. The multilayer ceramic capacitor according to claim 18, wherein the outer electrode film includes glass and metal.

20. The multilayer ceramic capacitor according to claim 18, wherein a thickness of the outer electrode film is greater than or equal to about 3 μm and less than or equal to about 100 μm.
